(19) United States
(12) Patent Application Publication
(10) Pub. No.: US 2025/0312736 A1
(43) Pub. Date: Oct. 9, 2025

(54) CHLORINE GAS DECOMPOSITION CATALYST AND EXHAUST GAS TREATMENT APPARATUS

(71) Applicant: Resonac Corporation, Tokyo (JP)

(72) Inventors: Kunchan LEE, Tokyo (JP); Kazuki IWAGAKI, Tokyo (JP); Toshinori MORIYA, Tokyo (JP)

(73) Assignee: Resonac Corporation, Tokyo (JP)

(21) Appl. No.: 18/865,513

(22) PCT Filed: May 22, 2023
(86) PCT No.: PCT/JP2023/018851

§ 371 Date: Nov. 13, 2024

(30) Foreign Application Priority Data
May 25, 2022 (JP) 2022-085453

(51) Int. Cl. B01D 53/86; B01J 21/04; B01J 23/83; B01J 35/54; B01J 35/61; B01J 35/63; B01J 35/64; B01J 37/00; B01J 37/08

(52) U.S. Cl. CPC B01D 53/8659; B01D 53/8696; B01J 21/04; B01J 23/83; B01J 35/54; B01J 35/615; B01J 35/633; B01J 35/635; B01J 35/647; B01J 37/0009; B01J 37/08; B01D 2255/2065; B01D 2255/20746; B01D 2255/40; B01D 2257/2025; B01D 2257/2066; B01D 2258/02

(57) ABSTRACT

[Technical Problem] To provide a chlorine gas decomposition catalyst that can remove chlorine gas contained in, for example, exhaust gas, with high efficiency, and is less likely to reduce catalyst components when used.

[Solution to Problem] A chlorine gas decomposition catalyst, including a composite oxide (X) of Al and at least one element M1 selected from the group consisting of Ce and Co.

### TECHNICAL FIELD

The present invention relates to a chlorine gas decomposition catalyst, and an exhaust gas treatment apparatus and a method for decomposing chlorine gas using the catalyst.

### BACKGROUND ART

Among gases (hereinafter may be referred to as “exhaust gases”) discharged from, for example, processes for manufacturing compounds and various industrial processes, chlorine gas may be included. Chlorine gas is toxic and required to be removed, and therefore various methods have been conventionally employed to remove it.

For example, Patent Literature 1 and 2 discloses a method for removing chlorine gas by bringing exhaust gas containing chlorine gas into contact with an alkaline solution. Moreover, Patent Literature 3 and 4 discloses a method for removing chlorine gas by adsorbing halogen-based gases such as chlorine gas onto an adsorbent (an abatement agent) containing zeolite.

### CITATION LIST

### Patent Literature

[Patent Literature 1] JP2005-305414A
[Patent Literature 2] JP2008-110339A
[Patent Literature 3] JP2008-229610A
[Patent Literature 4] JP2016-155072A

### SUMMARY OF INVENTION

### Technical Problem

However, conventional methods for removing chlorine gas have had room for further improvement in terms of efficiency of removing chlorine gas.

The present inventors have found that such problems can be solved by using a chlorine gas decomposition catalyst including oxide(s) of Ce and/or Co. However, using this catalyst may have arisen problems that catalyst components are reduced, i.e., a portion of the catalyst components supported on a support may have been rubbed and delaminated from the support when a reactor is filled with the catalyst, or may have been eluted when used.

An object of the present invention is therefore to provide, for example, a chlorine gas decomposition catalyst, a chlorine gas removal apparatus, and a chlorine gas removal method which can remove chlorine gas contained in, for example, exhaust gas with high efficiency, and are less likely to reduce catalyst components when used.

### Solution to Problem

The present invention relates to, for example, the following [1] to [17].

[1]

A chlorine gas decomposition catalyst, including a composite oxide (X) of Al and at least one element M1 selected from the group consisting of Ce and Co.

[2]

The chlorine gas decomposition catalyst according to [1], wherein the composite oxide (X) has a Ce content of 5% by mass or more and a Co content of 5% by mass or more.

[3]

The chlorine gas decomposition catalyst according to [1] or [2], wherein the composite oxide (X) is a composite oxide of the element M1, Al and Cu.

[4]

The chlorine gas decomposition catalyst according to [3], wherein the composite oxide (X) has a Cu content of 0.1% by mass or more.

[5]

The chlorine gas decomposition catalyst according to any one of [1] to [4], having a specific surface area of 50 m²/g or more, a total pore volume of 0.3 cm³/g or more and an average pore diameter of 5 nm or more.

[6]

The chlorine gas decomposition catalyst according to any one of [1] to [5], wherein the composite oxide (X) is a porous substance.

[7]

The chlorine gas decomposition catalyst according to any one of [1] to [6], for decomposing chlorine gas contained in exhaust gas.

[8]

The chlorine gas decomposition catalyst according to [7], wherein the exhaust gas contains a perfluoro compound.

[9]

An exhaust gas treatment apparatus including a reactor into which exhaust gas containing chlorine gas is introduced, wherein the reactor is equipped with the chlorine gas decomposition catalyst according to any one of [1] to [8].

The exhaust gas treatment apparatus according to [9], wherein the exhaust gas contains a perfluoro compound.

The exhaust gas treatment apparatus according to [10], further including a reactor filled with a perfluoro compound decomposition catalyst.

The exhaust gas treatment apparatus according to any one of [9] to [11], including a supply device that supplies water to the exhaust gas.

The exhaust gas treatment apparatus according to any one of [9] to [12], including a heating device that heats the exhaust gas.

The exhaust gas treatment apparatus according to [13], including a temperature detector that detects a temperature of the exhaust gas supplied to the reactor, and a control device that controls the heating device based on a temperature measured by the temperature detector.

The exhaust gas treatment apparatus according to any one of [9] to [14], including a cooling device that cools gas discharged from the reactor.

The exhaust gas treatment apparatus according to any one of [9] to [15], including a removal device that removes an acid gas from gas discharged from the reactor.

A method for decomposing chlorine gas, including bringing gas containing chlorine gas into contact with the chlorine gas decomposition catalyst according to any one of [1] to [8] in the presence of water.

### Advantageous Effects of Invention

By using of the chlorine gas decomposition catalyst of the present invention, chlorine gas contained in, for example, exhaust gas, can be removed with high efficiency. Moreover, the chlorine gas decomposition catalyst of the present invention is less likely to reduce catalyst components when used.

### BRIEF DESCRIPTION OF DRAWING

FIG. 1 is a configuration view of one embodiment of the exhaust gas treatment apparatus of the present invention.

### DESCRIPTION OF EMBODIMENT

The present invention will be described in more detail below.

In a numerical range described in the present disclosure, the upper limit value or lower limit value of the numerical range may be replaced with the values shown in Examples. Furthermore, the lower limit value and upper limit value of the numerical range are arbitrarily combined with the lower limit value or upper limit value of other numerical range. In the expression numerical range “AA to BB,” the numerical values at both ends, AA and BB, are included in the numerical range as a lower limit value and an upper limit value, respectively.

### [Chlorine Gas Decomposition Catalyst]

The chlorine gas decomposition catalyst according to the present invention includes a composite oxide (X) of Al and at least one element M1 selected from the group consisting of Ce and Co. In the composite oxide (X), for the purpose of allowing a decomposition reaction of chlorine gas to proceed uniformly, it is preferable that little bias of the elements M1 and Al in their distribution and the elements M1 and Al are approximately uniformly distributed.

The chlorine gas decomposition catalyst can be used to decompose chlorine gas contained in exhaust gas. The exhaust gas may contain a perfluoro compound.

The composite oxide (X) is a composite oxide of Al and at least one element M1 selected from the group consisting of Ce and Co. That is, examples of the composite oxides (X) include a composite oxide of Al and Ce, a composite oxide of Al and Co, and a composite oxide of Al, Ce, and Co. Of these, from the viewpoint of catalytic activity to decompose chlorine gas, a composite oxide of Al, Ce, and Co is preferable.

The composite oxide (X) may be a composite oxide of the element M1, Al, and an element other than these, specifically, a composite oxide of at least one element M2 selected from the group consisting of Mg, Cr, Mn, Fe, Ni, Cu, and Zr, the element M1, and Al.

The element M2 is preferably Cu.

The composite oxide (X) further containing Cu in addition to Al, Ce, and Co tends to have a higher catalytic activity to decompose chlorine gas. Therefore, the composite oxide (X) is more preferably a composite oxide of Al, Ce, Co, and Cu.

The composite oxide (X) has an element M1 content of preferably 5% by mass or more, more preferably 5 to 40% by mass, and still more preferably 5 to 25% by mass, relative to the composite oxide (X).

The composite oxide (X) has a Ce content of preferably 5% by mass or more, more preferably 5 to 40% by mass, and still more preferably 5 to 20% by mass, relative to the composite oxide (X).

The composite oxide (X) has a Co content of preferably 5% by mass or more, more preferably 5 to 40% by mass, and still more preferably 5 to 20% by mass, relative to the composite oxide (X).

When the composite oxide (X) contains both Ce and Co, the mass ratio of Co to Ce (Co/Ce) is preferably 0.25 to 4.0 and more preferably 0.5 to 1.0.

When containing the element M2, the composite oxide (X) has an element M2 content, for example, a Cu content of preferably 0.01 to 5.0% by mass, more preferably 0.01 to 1.0% by mass, and still more preferably 0.01 to 0.5% by mass, relative to the composite oxide (X). The composite oxide (X) may have a Cu content of 0.1% by mass or more, 0.1 to 5.0% by mass, 0.1 to 1.0% by mass, or 0.1 to 0.5% by mass.

The Al content of the composite oxide (X) depends on the content of Ce, Co and M2, and may be, for example, approximately 25 to 50% by mass, and is preferably 25 to 40% by mass, relative to the composite oxide (X).

The composite oxide (X) is preferably a porous substance since the porous substance can decompose chlorine with high efficiency. The chlorine gas decomposition catalyst according to the present invention specifically has the following physical properties.

The chlorine gas decomposition catalyst has a specific surface area of preferably 50 m²/g or more and more preferably 100 m²/g or more, and the upper limit thereof may be, for example, 500 m²/g. Within the above range of the specific surface area, the catalyst of the present invention has a high density of active sites per catalyst weight and exhibits its high activity. The specific surface area is the value measured using a BET method under the conditions adopted in Examples.

The chlorine gas decomposition catalyst has a total pore volume of preferably 0.3 cm³/g or more and more preferably 0.4 cm³/g or more, and the upper limit thereof may be, for example, 1.0 cm³/g.

The total pore volume within the above range, i.e., a larger pore volume per catalyst weight, provides many reaction sites for the catalyst and allows a catalytic reaction of chlorine gas to be likely to occur. The total pore volume is the value measured by a method described in Examples.

The chlorine gas decomposition catalyst has an average pore diameter of preferably 5 nm or more and more preferably 10 nm or more, and the upper limit thereof may be, for example, 30 nm.

When the average pore diameter is within the above range, chlorine gas and water vapor necessary for decomposing chlorine gas become easier to enter pores, and hydrochloric acid gas and oxygen gas generated after decomposition of chlorine gas become easier to be discharged. The value of the average pore diameter is the value measured by a method adopted in Examples described later.

The chlorine gas decomposition catalyst according to the present invention may contain an additive (for example, an inorganic binder) contained in a catalyst precursor described later or a component derived from the additive, within a range that does not impair the effects of the present invention.

Examples of forms of the chlorine gas decomposition catalyst according to the present invention include a pellet, a film, and a fiber, and among these, a pellet is preferable. The pellet refers to a granulated material solidified into a certain shape such as a sphere or a cylinder.

From the viewpoint of increasing a contact area between reaction gas and the catalyst and reducing a pressure loss in a reactor, the pellet is preferably cylindrical, columnar or spherical. Furthermore, from the manufacturing viewpoint of reducing the number of steps and enabling stable production, the pellet is preferably cylindrical or columnar. Of these, from the viewpoint of facilitating gas to flow in a catalytic reactor and capable of increasing catalytic reactivity, the pellet is particularly preferably cylindrical.

In the case of a cylindrical shape, the outer diameter of the cylinder may be, for example, 2 to 10 mm, the diameter of a central cavity may be, for example, 1 to 9 mm, and the length may be, for example, 2 to 50 mm.

### (Method for Producing Chlorine Gas Decomposition Catalyst)

Examples of the method for producing a chlorine gas decomposition catalyst according to the present invention include a production method that includes
a step (1) of mixing each raw material component of the composite oxide (X) to prepare a catalyst precursor,
a step (2) of molding the catalyst precursor to prepare a precursor molded product, and
a step (3) of calcinating the precursor molded product to obtain a chlorine gas decomposition catalyst including the composite oxide (X).

### <Step (1)>

In the step (1), each raw material component of the composite oxide (X) is mixed to prepare a catalyst precursor.

Examples of the raw material components include salts of Al, the element M1, and the element M2, respectively. The salts may be hydrates.

Examples of the salts include nitrates, chlorides, bromides, sulfates, and carbonates, of which nitrates and chlorides are preferred, and nitrates are further preferred.

Specific examples of the nitrates include aluminum nitrate nonahydrate, cerium (III) nitrate hexahydrate, cobalt (II) nitrate hexahydrate, and copper (II) nitrate trihydrate.

The raw material component may be an oxide of some of metals constituting the composite oxide (X). Examples of the oxides include cobalt oxide (Co₃O₄), cerium oxide (CeO₂), and aluminum oxide. An average particle size of the oxide, for example, the D50 value measured by the method employed in Examples, is preferably 0.1 to 10 μm.

Furthermore, of the raw material components, examples of aluminum sources of the composite oxide (X) include preferably aluminum hydroxide and more preferably boehmite from the viewpoint of thermally decomposing the aluminum source upon calcination in a step (3) described later to promote rendering the composite oxide (X) porous.

The catalyst precursor may contain an additive in addition to the raw material components, or may not contain an additive from the viewpoint of preventing impurities from remaining.

Examples of the additives include a pore-forming agent, a molding aid, and a binder.

The pore-forming agent is an additive for forming pores in the composite oxide (X) by heating, and a conventionally known agent can be used. Controlling a particle size of the pore-forming agent and the amount thereof added enables controlling the pore diameter and pore volume of pores formed in the composite oxide (X), and specific surface area of the composite oxide (X), for example.

Examples of the pore-forming agents include chemical foaming agents in granular form, such as toluenesulfonyl hydrazide, benzenesulfonyl hydrazide, azodicarbonamide, and H₂NCO—N═N—CONH₂. By vaporizing and eliminating these by heating, a composite oxide (X) having controlled pores can be obtained.

Examples of the pore-forming agents further include a foaming agent composed of a thermoplastic shell in which a liquid hydrocarbon is encapsulated. Vaporizing a hydrocarbon by heating to expand the thermoplastic shell enables providing a composite oxide (X) with controlled pores.

The molding aid has functions such as increasing flowability of the catalyst precursor when molded by, for example, extrusion molding in a step (2) described later.

Examples of the molding aid include lubricants and mineral oils.

The binder contributes to maintaining shapes of a precursor molded product obtained in the step (2) described later and a chlorine gas decomposition catalyst produced.

Examples of the binders include organic binders such as polyolefin oxide, oil, acacia, a carbonaceous material, cellulose, a substituted cellulose, a cellulose ether, stearate, wax, a granulated polyolefin, polystyrene, polycarbonate, sawdust, crushed nutshell powder, a polyvinyl alcohol, and polyvinyl butyral, and inorganic binders such as silica and clay minerals.

The inorganic binder may be left without disappearing even after calcination in the step (3) described later, in the chlorine gas decomposition catalyst.

In the step (1), the catalyst precursor is prepared by, for example, a method that includes:
a step of dissolving or dispersing the raw material components excluding an aluminum source in water to prepare a raw material solution (provided that the solution also includes liquid in dispersion form), and
a step of kneading the raw material solution with aluminum hydroxide, which is a raw material component of Al, and optionally water.

The proportion of each raw material component contained in the catalyst precursor is appropriately adjusted according to a composition of the composite oxide (X) to be produced.

The amount of water contained in the catalyst precursor may be, for example, 10 to 50% by mass.

The step (1) may be carried out under an atmospheric pressure or reduced pressure.

The step (1) may be carried out in the vicinity of room temperature (for example, 5 to 40° C.), or may be carried out at a higher temperature (for example, 40 to 85° C.) by heating.

### <Step (2)>

In the step (2), the catalyst precursor obtained in the step (1) is molded to prepare a precursor molded product.

As a molding method, an extrusion molding method is preferable since it requires fewer steps upon catalyst preparation, the manufacturing conditions are easily controlled, and mass production is easy.

The form of the precursor molded product is selected according to a form of the chlorine gas decomposition catalyst to be produced, and is usually a pellet.

From the viewpoint of reducing a gas pressure loss in a reactor, the shape of the pellet is preferably a cylindrical shape (details of the dimensions are as described above).

The precursor molded product is preferably dried in order to remove moisture from the precursor molded product before carrying out the next step (3). Removing moisture can inhibit cracks from occurring, for example, upon calcination. The drying can be carried out by a conventionally known means such as air drying and heating.

The drying is carried out, for example, under the following conditions.
Temperature: Temperature at which supported material components do not decompose (for example, room temperature to 300° C.).
Time: 0.5 to 50 hours.
Pressure: At ordinary or reduced pressure.
Atmosphere: Air, inert gases (for example, argon gas, nitrogen gas, and helium gas), oxygen gas, or a mixture of these gases.

### <Step (3)>

In the step (3), the precursor molded product obtained in the step (2) is calcined to obtain the chlorine gas decomposition catalyst including the composite oxide (X).

The calcination is carried out, for example, under the following conditions.
Temperature: 300 to 1200° C. and preferably 400 to 800° C.
Time: 0.5 to 10 hours and preferably 1 to 5 hours.
Pressure: Ordinary pressure, reduced pressure or pressurized pressure.
Atmosphere: Air, inert gases (for example, argon gas, nitrogen gas, and helium gas), oxygen gas, or a mixture of these gases.

### [Exhaust Gas Treatment Apparatus]

The exhaust gas treatment apparatus according to the present invention comprises a vessel into which exhaust gas containing chlorine gas is introduced, i.e., a reactor, wherein the reactor includes the chlorine gas decomposition catalyst according to the present invention.

The exhaust gas treatment apparatus according to the present invention will be described while referring to the drawings.

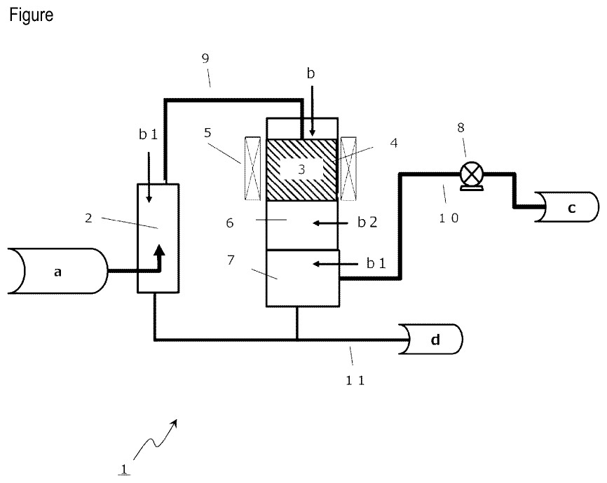

FIG. 1 is a configuration view of one embodiment of the exhaust gas treatment apparatus of the present invention. The exhaust gas treatment apparatus 1 of the present embodiment includes a first removal device (also referred to as a “scrubber”) 2 in which scrubber water b1 is poured by, for example, a spray (not shown) into an exhaust gas a containing chlorine gas, a reactor 4 into which the exhaust gas that has passed through the first removal device 2 is introduced via a pipe 9 and into which water b is also introduced to carry out a decomposition reaction of chlorine gas in the exhaust gas, a cooling device 6 that cools the exhaust gas that has passed through the reactor 4, a second removal device (also referred to as a “scrubber”) 7 in which scrubber water b1 is poured by, for example, a spray (not shown) into the exhaust gas that has passed through the cooling device 6, and a blower 8 for sending the treated exhaust gas that has passed through the second removal device 7 out of the system via a pipe 10.

The inside of the reactor 4 is filled with the chlorine gas decomposition catalyst 3, and a heating device 5 is installed in a circumference of the reactor 4.

The reactor 4 can be appropriately sized depending on, for example, a type of the exhaust gas a, a scale of the exhaust gas treatment apparatus 1.

Examples of the exhaust gas a include gases discharged from, for example, processes for manufacturing compounds and various industrial processes, and examples of such gases include a greenhouse gas (GHG), a harmful gas, a flammable gas, and an odorous gas. Specific examples thereof include etching gases used in processes for manufacturing semiconductors or liquid crystals, or cleaning gases used in CVD apparatus. These exhaust gases may contain a perfluoro compound. Examples of the perfluoro compounds include CF₄, CHF₃, C₂F₆, C₃F₈, CAF₈, SF₆, and NF₃.

The exhaust gas treatment apparatus 1 may include a reactor (not shown) filled with a perfluoro compound decomposition catalyst 9 (not shown) together with the reactor 4 filled with the chlorine gas decomposition catalyst 3. The perfluoro compound decomposition catalyst 9 may be a conventionally known catalyst, for example, a nickel oxide catalyst.

Use of the chlorine gas decomposition catalyst according to the present invention as the chlorine gas decomposition catalyst 3 and combined use of the reactor 4 including the chlorine gas decomposition catalyst 3 and a reactor (not shown) containing the perfluoro compound decomposition catalyst 9, that is, use of the exhaust gas treatment apparatus 1 configured so that the exhaust gas a passes through one reactor and then the other reactor, enables decomposing not only perfluoro compounds but also chlorine gas with high efficiency even when the exhaust gas a contains a perfluoro compound.

The exhaust gas treatment apparatus 1 according to the present invention preferably comprises a supply device that supplies water b to the exhaust gas a introduced into the reactor 4. This supply device provided allows a decomposition reaction of chlorine gas described below to be smoothly carried out even though the exhaust gas a does not originally contain water. Examples of the device that supplies water include a device that transfers water using a pump or a compressor and sprays it from a nozzle.

The exhaust gas treatment apparatus 1 preferably includes a heating device 5 for heating an exhaust gas containing chlorine gas to a temperature at which a decomposition reaction of chlorine gas is carried out. Examples of the heating device 5 include an electric heater 5a that uses electric energy for heating, or a heating device that passes high-temperature gas through.

For example, the reactor 4 may include the heating device 5 (for example, the heating device 5 installed in the circumference of the reactor) for heating an inside of the reactor 4 to a temperature at which a decomposition reaction of chlorine gas is carried out, or the exhaust gas treatment apparatus 1 may include a heating device (not shown) for heating an exhaust gas containing chlorine gas to a temperature at which a decomposition reaction of chlorine gas is carried out before the gas is introduced into the reactor 4.

The exhaust gas treatment apparatus 1 is preferably equipped with a cooling device 6 that cools gas discharged from the reactor 4. Examples of this cooling device 6 preferably include a device that brings the gas into contact with cooling water in the cooling device 6 (for example, a spray for spraying cooling water b2). By bringing the gas into contact with cooling water, hydrogen chloride, which is a product of decomposition reaction of chlorine gas contained in the gas, and further hydrogen fluoride, which is a product of the decomposition reaction of a perfluoro compound when the exhaust gas a contains it, can be dissolved into the cooling water and removed.

The exhaust gas treatment apparatus 1 preferably includes an abatement device (not shown) that abates cooling water (hereinafter also referred to as “exhaust liquid”) in which hydrogen chloride, for example, is dissolved. The exhaust liquid and scrubber water b1 are recovered through a pipe 11, and preferably sent out of the system after having been abated.

The exhaust gas treatment apparatus 1 preferably includes a removal device (for example, a second removal device 7) that removes an acid gas (hydrogen chloride gas, hydrogen fluoride gas) from gas discharged from the reactor 4 and passed through the cooling device 6.

The exhaust gas treatment apparatus preferably includes a temperature detector that detects the temperature of the exhaust gas a supplied to the reactor 4, and a control device (for example, a computer) that controls the heating device 5 based on the temperature measured by the temperature detector. Controlling the heating device 5 means that, for example, current of the electric heater 5a is adjusted to maintain the temperature at which a decomposition reaction of chlorine gas is carried out.

When the exhaust gas treatment apparatus 1 is used to treat perfluoro compound gas containing chlorine gas, the exhaust gas treatment apparatus 1 preferably includes an abatement device (not shown) that abates the perfluoro compound gas.

### [Decomposition Method of Chlorine Gas]

The method for decomposing chlorine gas according to the present invention includes bringing a gas containing chlorine gas into contact with the chlorine gas decomposition catalyst according to the present invention in the presence of water.

By bringing the gas containing chlorine gas into contact with the chlorine gas decomposition catalyst according to the present invention in the presence of water (this water is usually water vapor) enables the following reaction to occur and decomposition of chlorine gas.

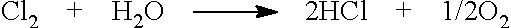

The proportion of chlorine gas in the gas containing chlorine gas is, for example, 0.1 to 10% by volume and preferably 0.1 to 1% by volume at 25° C. and 1 atmospheric pressure.

The gas containing chlorine gas preferably contains water. The proportion of water in the gas containing chlorine gas is, for example, 1 to 40% by volume and preferably 10 to 25% by volume. The volume described here is a value that is converted under standard conditions (0° C., 1.01×10⁵ Pa).

Examples of gases other than chlorine gas and water vapor in the gas containing chlorine gas include, for example, nitrogen gas and argon gas.

The decomposition reaction of chlorine gas is carried out, for example, under the following conditions.
Temperature: 300 to 1,000° C. and preferably 400 to 800° C.
Pressure: Ordinary pressure or pressurized pressure and preferably ordinary pressure.

According to the method for decomposing chlorine gas according to the present invention, it is possible to decompose chlorine gas and particularly chlorine gas contained in exhaust gas, at a high decomposition rate.

According to the method for decomposing chlorine gas according to the present invention, chlorine gas contained in exhaust gas containing perfluoro compound gas can also be decomposed at a high decomposition rate.

When the exhaust gas a contains perfluoro compound gas, it is preferable to decompose chlorine gas and the perfluoro compound by, for example, a catalyst and plasma to abate the exhaust gas a and then discharge the abated exhaust gas c generated from the exhaust gas a to an outside of the system. Herein, the abated exhaust gas c refers to exhaust gas in which chlorine gas is significantly reduced in amount compared to the exhaust gas a. Furthermore, before the abated exhaust gas c and abated exhaust liquid d are discharged to an outside of the system, a perfluoro compound as well as a compound generated by decomposing chlorine gas and the perfluoro compound may preferably undergo abatement treatment, if necessary. Also, after the abated exhaust gas c and abated exhaust liquid d are discharged to an outside of the system, the perfluoro compound and compound generated by decomposing chlorine gas and the perfluoro compound may undergo abatement treatment.

Conventional methods for removing chlorine gas using an adsorbent have had an inconvenience of requiring frequent exchange of the adsorbent. However, the method for decomposing chlorine gas according to the present invention makes it possible to remove chlorine gas without frequent exchange of the catalyst.

### EXAMPLES

Hereinafter, the present invention will be further specifically described based on the Examples, but the present invention is not limited to the Examples.

### (Raw Materials)

The raw materials used in, for examples, the following Examples are as follows:
Cobalt oxide (Co₃O₄) (manufactured by FUJIFILM Wako Pure Chemical Corporation)
Cerium (III) nitrate hexahydrate (manufactured by FUJIFILM Wako Pure Chemical Corporation)
Cobalt (II) nitrate hexahydrate (manufactured by FUJIFILM Wako Pure Chemical Corporation)
Copper (II) nitrate trihydrate (manufactured by FUJIFILM Wako Pure Chemical Corporation)
Dried boehmite powder (manufactured by Union Showa K. K.)

### [Preparation of Cobalt Oxide Powder]

In the following Examples etc., purchased cobalt oxide was crushed using a planetary ball mill so that the cobalt oxide has a D50 of approximately 1 μm in the particle size distribution measured by a laser diffraction/scattering method and then used.

The particle size distribution was measured as follows.

A very small spatula amount of cobalt oxide powder was placed in a small glass bottle, to which 2 mL of 98% by weight ethanol was added, and the mixture was dispersed ultrasonically for 5 minutes. This solution was fed in a laser diffraction particle size distribution analyzer (Microtrac MT-3000) manufactured by MicrotracBell Corporation, and a volume-based cumulative particle size distribution was measured to confirm that a 50% particle size (D50) was 1 μm.

### (Catalyst Fabrication)

### Example 1

125 g of cobalt oxide, 490 g of cerium (III) nitrate hexahydrate, 125 g of cobalt (II) nitrate hexahydrate, 10 g of copper (II) nitrate trihydrate, and 250 g of pure water were mixed to obtain a raw material solution. Note that the cobalt oxide is dispersed in the raw material solution.

Using a high-shear kneader and an extruder, 880 g of the raw material solution, 1,070 g of dried boehmite powder, and 50 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 3 hours to obtain a chlorine gas decomposition catalyst (1).

### Example 2

110 g of cobalt oxide, 490 g of cerium (III) nitrate hexahydrate, 110 g of cobalt (II) nitrate hexahydrate, 10 g of copper (II) nitrate trihydrate, and 280 g of pure water were mixed to obtain a raw material solution.

Using a high-shear kneader and an extruder, 880 g of the raw material solution, 1,060 g of dried boehmite powder, and 60 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 3 hours to obtain a chlorine gas decomposition catalyst (2).

### Example 3

115 g of cobalt oxide, 370 g of cerium (III) nitrate hexahydrate, 115 g of cobalt (II) nitrate hexahydrate, and 400 g of pure water were mixed to obtain a raw material solution.

Using a high-shear kneader and an extruder, 920 g of the raw material solution, 1,040 g of dried boehmite powder, and 40 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 3 hours to obtain a chlorine gas decomposition catalyst (3).

### Example 4

125 g of cobalt oxide, 490 g of cerium (III) nitrate hexahydrate, 125 g of cobalt (II) nitrate hexahydrate, 10 g of copper (II) nitrate trihydrate, and 250 g of pure water were mixed to obtain a raw material solution.

Using a high-shear kneader and an extruder, 890 g of the raw material solution, 1,060 g of dried boehmite powder, and 50 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 4 hours to obtain a chlorine gas decomposition catalyst (4).

### Example 5

125 g of cobalt oxide, 490 g of cerium (III) nitrate hexahydrate, 125 g of cobalt (II) nitrate hexahydrate, and 260 g of pure water were mixed to obtain a raw material solution.

Using a high-shear kneader and an extruder, 880 g of the raw material solution, 1,060 g of dried boehmite powder, and 60 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 3 hours to obtain a chlorine gas decomposition catalyst (5).

### Example 6

120 g of cobalt oxide, 550 g of cerium (III) nitrate hexahydrate, 120 g of cobalt (II) nitrate hexahydrate, 10 g of copper (II) nitrate trihydrate, and 200 g of pure water were mixed to obtain a raw material solution.

Using a high-shear kneader and an extruder, 880 g of the raw material solution, 1,070 g of dried boehmite powder, and 50 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 5 hours to obtain a chlorine gas decomposition catalyst (6).

### Example 7

160 g of cobalt oxide, 480 g of cerium (III) nitrate hexahydrate, 160 g of cobalt (II) nitrate hexahydrate, and 200 g of pure water were mixed to obtain a raw material solution.

Using a high-shear kneader and an extruder, 1,000 g of the raw material solution, 960 g of dried boehmite powder, and 40 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 3 hours to obtain a chlorine gas decomposition catalyst (7).

### Example 8

160 g of cobalt oxide, 490 g of cerium (III) nitrate hexahydrate, 160 g of cobalt (II) nitrate hexahydrate, 10 g of copper (II) nitrate trihydrate, and 180 g of pure water were mixed in these amounts to obtain a raw material solution.

Using a high-shear kneader and an extruder, 1,000 g of the raw material solution, 960 g of dried boehmite powder, and 40 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 5 hours to obtain a chlorine gas decomposition catalyst (8).

### Example 9

160 g of cobalt oxide, 490 g of cerium (III) nitrate hexahydrate, 160 g of cobalt (II) nitrate hexahydrate, 10 g of copper (II) nitrate trihydrate, and 180 g of pure water were mixed in these amounts to obtain a raw material solution.

Using a high-shear kneader and an extruder, 1,000 g of the raw material solution, 960 g of dried boehmite powder, and 40 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 2 hours to obtain a chlorine gas decomposition catalyst (9).

### Example 10

125 g of cobalt oxide, 500 g of cerium (III) nitrate hexahydrate, 125 g of cobalt (II) nitrate hexahydrate, 10 g of copper (II) nitrate trihydrate, and 240 g of pure water were mixed to obtain a raw material solution.

Using a high-shear kneader and an extruder, 900 g of the raw material solution, 1,070 g of dried boehmite powder, and 30 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 2 hours to obtain a chlorine gas decomposition catalyst (10).

### Example 11

700 g of cerium (III) nitrate hexahydrate and 300 g of pure water were mixed in these amounts to obtain a raw material solution.

Using a high-shear kneader and an extruder, 860 g of the raw material solution, 1,080 g of dried boehmite powder, and 60 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 5 hours to obtain a chlorine gas decomposition catalyst (11).

### Example 12

300 g of cobalt oxide, 250 g of cobalt (II) nitrate hexahydrate, and 450 g of pure water were mixed to obtain a raw material solution.

Using a high-shear kneader and an extruder, 880 g of the raw material solution, 1060 g of dried boehmite powder, and 60 g of polyvinyl alcohol as a binder were kneaded at room temperature for not less than 30 minutes, and the kneaded product obtained was extrusion-molded to obtain a number of cylindrical pelletized molded products with a diameter of 3.2 mm and a length of 10 mm (with an inner diameter of 1 mm). The obtained molded products were dried in a hot air dryer at 60° C. for 12 hours, and then calcined in air at 750° C. for 5 hours to obtain a chlorine gas decomposition catalyst (12).

### Comparative Example 1

As a chlorine gas decomposition catalyst (c1), a commercially available activated alumina porous body (3.0 mm diameter spherical pellet, NKHD-24, manufactured by Sumitomo Chemical Co., Ltd.) was prepared.

### Comparative Example 2

As a chlorine gas decomposition catalyst (c2), a commercially available activated alumina porous body (3.0 mm diameter spherical pellet, NST-3, manufactured by Nikki-Universal Co., Ltd.) was prepared.

### Comparative Example 3

As a chlorine gas decomposition catalyst (c3), a commercially available silica alumina catalyst (3.0 mm diameter cylindrical pellet, 822HOD3A, manufactured by Tosoh Corporation) was prepared.

### Comparative Example 4

13.8 g of cerium (III) nitrate hexahydrate, 3.5 g of cobalt (II) nitrate hexahydrate, and 0.1 g of copper (II) nitrate trihydrate, were dissolved in 53 mL of pure water to obtain a solution (impregnating solution). Employing a pore-filling method, that is, 39.0 g of a γ-alumina porous body (NST-3 manufactured by Nikki-Universal Co., Ltd.) as a support was added to this aqueous solution (impregnating solution) and was brought into contact with cerium nitrate, cobalt nitrate, and copper nitrate to obtain a support (c4a) (γ-alumina porous body supporting cerium nitrate, cobalt nitrate, and copper nitrate).

The support (c4a) was air-dried at room temperature for 1 hour, further dried at 60° C. for 24 hours, and then calcined in air at 500° C. for 2 hours to obtain a support (c4b).

Next, 3.5 g of cobalt oxide was crushed in a planetary ball mill so that cobalt oxide has a D50 in the particle size distribution measured by a laser diffraction/scattering method of 1 μm, added in 53 mg of pure water, and dispersed by irradiation with ultrasound to obtain a dispersion (impregnating solution). Employing the pore filling method, i.e., a support (c4b) which was placed in this dispersion liquid allows the γ-alumina porous body to be further brought into contact with cobalt oxide to obtain a support (c4c).

The support (c4c) was air-dried at room temperature for 1 hour, further dried at 60° C. for 24 hours, and then calcined in air at 500° C. for 2 hours to obtain a chlorine gas decomposition catalyst (c4).

### [Analysis or Evaluation of Catalyst]

The analysis or evaluation of the chlorine gas decomposition catalysts obtained in each of Examples and Comparative Examples was performed as follows. The results are shown in Tables 1 and 2.

### (BET Specific Surface Area)

The specific surface area was measured using a nitrogen adsorption measurement apparatus (Belsorp Max) manufactured by MicrotracBell Corporation. The amount of sample was 0.1 to 0.2 g, and a vacuum heating treatment was performed at 200° C. for 3 hours as pretreatment. The amounts of N₂ adsorption and desorption were observed at liquid nitrogen temperature using the nitrogen adsorption measurement apparatus, and the adsorption and desorption isotherms were obtained. The specific surface area was calculated in a relative pressure range of 0.1 to 0.3 in the adsorption isotherm, using a BET method.

### (Total Pore Volume and Average Pore Diameter)

The total pore volume and average pore diameter were measured using a nitrogen adsorption measurement apparatus (Belsorp Max) manufactured by MicrotracBell Corporation. The sample weight was 0.1 to 0.2 g, and vacuum heating treatment was performed at 200° C. for 3 hours as pretreatment. The amounts of N₂ adsorption and desorption were observed at liquid nitrogen temperature using the nitrogen adsorption measurement apparatus to obtain adsorption and desorption isotherms. The total pore volume and average pore diameter were calculated by the BJH method using the adsorption isotherm data.

### (Elemental Analysis (Inductively Coupled Plasma Method (ICP-AES Method)))

Approximately 0.01 g of the catalyst, which had been ground in an agate mortar, was weighed into a quartz beaker and dissolved with either HCl, H₂SO₄, or HNO₃ by acid decomposition. After cooling, the volume was adjusted to 100 mL and a qualitative analysis was performed using the ICP-AES method. The analysis was performed with n=1. (Apparatus: Agilent 5110 (Agilent technology Inc))

### (Chlorine Gas Decomposition Measurement)

A reaction tube made of Inconel (70 cc in volume) was filled with the chlorine gas decomposition catalyst obtained in each of Examples and Comparative Examples. In this case, the reaction tube was filled with each catalyst prepared so that the reaction tube of 70 cc in volume was filled up. Upon the reaction, the amount of each gas was adjusted so that a mixed gas had a volume ratio of chlorine gas:nitrogen gas:water vapor in the reaction tube was 1:84:15 (in terms of volumes at 0° C. and 1.01×10⁵ Pa), and the mixed gas was supplied into the reaction tube at 5,000 cc/min (in terms of volume at 0° C. and 1.01×10⁵ Pa) under ordinary pressure. Specifically, chlorine gas and nitrogen gas were mixed by adjusting their volume ratio using mass flow controllers, and this gas with a flow rate being adjusted was introduced into the reaction tube. Pure water at ordinary temperature was introduced by a pump into a preheating section (400° C.) from an inlet different from an inlet for the mixed gas, while measuring its weight so as to achieve the above volume ratio, then vaporized and introduced into the reaction tube to be merged with the aforementioned mixed gas of chlorine gas and nitrogen gas. The reaction tube was heated to 750° C. in an electric furnace, and one hour after the start of the reaction, gas at an outlet of the reaction tube was sampled by passing it through a potassium iodide aqueous solution, and the amount of chlorine gas was quantified by iodometric titration to measure a decomposition rate of chlorine gas, defined by the following formula:

$$Decomposition rate ( \% ) = \{ ( 1. - proportion of chlorine gas in outlet gas ( \% by volume ) ) / 1. \} \times 100$$

wherein the proportion of chlorine gas in the outlet gas was converted to a proportion under standard conditions (0° C. and 1.01×10⁵ Pa).

### (Measurement of Chlorine Gas Decomposition Upon Mixing of Perfluoro Compound)

A reaction tube made of Inconel (70 cc in volume) was filled with each of the chlorine gas decomposition catalysts obtained in Examples 9 and 10. In this case, the reaction tube was filled with each catalyst prepared so that the reaction tube of 70 cc in volume was filled up. Upon the reaction, the volume of each gas was adjusted so that a mixed gas had a volume ratio of C₄F₈ gas:chlorine gas:nitrogen gas:water vapor in the reaction tube was 0.5:0.5:84:15 (in terms of volumes at 0° C. and 1.01×10⁵ Pa), and the mixed gas was supplied into the reaction tube at 5,000 cc/min (in terms of volume at 0° C. and 1.01×10⁵ Pa) under ordinary pressure. Specifically, the C₄F₈ gas, chlorine gas and nitrogen gas were mixed by adjusting their volume ratio using mass flow controllers, and this gas with a flow rate being adjusted was introduced into the reaction tube. Pure water at ordinary temperature was introduced by a pump into a preheating section (400° C.) from an inlet different from an inlet for the mixed gas, while measuring its weight so as to achieve the above volume ratio, then vaporized and introduced into the reaction tube to be merged with the aforementioned mixed gas of C₄F₈ gas, chlorine gas and nitrogen gas. The reaction tube was heated to 750° C. in an electric furnace, and one hour after the start of the reaction, gas at an outlet of the reaction tube was sampled by passing it through an aqueous potassium iodide solution, and the amount of chlorine gas was quantified by iodometric titration to measure a decomposition rate of chlorine gas, defined by the following formula:

$$Decomposition rate ( \% ) = \{ ( 0.5 - proportion of chlorine gas in outlet gas ( \% by volume ) ) / 0.5 \} \times 100$$

wherein the proportion of chlorine gas in the outlet gas was converted to a proportion under standard conditions (0° C. and 1.01×10⁵ Pa).

The results are shown in Table 2.

### (Delamination of Catalyst Component)

The presence or absence of delamination of the catalyst component was confirmed for the chlorine gas decomposition catalyst obtained in each of Examples and Comparative Examples as follows. The results are shown in Table 1.

Delamination of catalyst components was visually confirmed to see whether the catalyst components fell off the catalyst when the reactor was filled with the catalyst in the above-mentioned chlorine gas decomposition measurement. In other words, it was visually confirmed whether the catalyst components (black) were attached to a jig or a container in contact with the catalyst from the time of catalyst preparation to the time of the reactor being filled therewith.

TABLE 1

| | | | | | | BET | | | | | |
|---|---|---|---|---|---|---|---|---|---|---|---|
| | | | | | | specific | Total | Average | | Chlorine | |
| | | | | | | surface | pore | pore | | decomposition | Delamination |
| | Composition ratio (% by mass) | | | | | area | volume | diameter | Production | rate | of catalyst |
| | Al | Co | Ce | Cu | Si | (m²/g) | (cm³/g) | (nm) | method | (%) | components |
| Example 1 | 36.0 | 7.5 | 11.8 | 0.2 | — | 150 | 0.59 | 16 | Kneading | 99.10 | None |
| | | | | | | | | | extrusion | | |
| Example 2 | 35.4 | 7.0 | 13.7 | 0.2 | — | 127 | 0.62 | 20 | Kneading | 99.16 | None |
| | | | | | | | | | extrusion | | |
| Example 3 | 34.6 | 6.8 | 8.8 | — | — | 148 | 0.55 | 15 | Kneading | 99.06 | None |
| | | | | | | | | | extrusion | | |
| Example 4 | 35.5 | 7.4 | 11.8 | 0.2 | — | 120 | 0.60 | 20 | Kneading | 99.08 | None |
| | | | | | | | | | extrusion | | |
| Example 5 | 36.0 | 7.5 | 11.8 | — | — | 136 | 0.62 | 18 | Kneading | 99.04 | None |
| | | | | | | | | | extrusion | | |
| Example 6 | 35.1 | 7.3 | 13.5 | 0.2 | — | 114 | 0.57 | 20 | Kneading | 99.06 | None |
| | | | | | | | | | extrusion | | |
| Example 7 | 32.5 | 10.1 | 12.3 | — | — | 118 | 0.50 | 17 | Kneading | 99.03 | None |
| | | | | | | | | | extrusion | | |
| Example 8 | 32.6 | 10.1 | 12.3 | 0.2 | — | 110 | 0.50 | 18 | Kneading | 99.16 | None |
| | | | | | | | | | extrusion | | |
| Example 9 | 31.2 | 9.9 | 12.0 | 0.2 | — | 128 | 0.53 | 16 | Kneading | 99.14 | None |
| | | | | | | | | | extrusion | | |
| Example 10 | 34.7 | 7.6 | 11.6 | 0.2 | — | 113 | 0.43 | 15 | Kneading | 99.36 | None |
| | | | | | | | | | extrusion | | |
| Example 11 | 38.3 | — | 16.7 | — | — | 118 | 0.60 | 21 | Kneading | 98.20 | None |
| | | | | | | | | | extrusion | | |
| Example 12 | 37.3 | 16.4 | — | — | — | 120 | 0.61 | 20 | Kneading | 98.70 | None |
| | | | | | | | | | extrusion | | |
| Comparative | 50.5 | — | — | — | — | 318 | 0.38 | 6 | Kneading | 96.40 | None |
| Example 1 | | | | | | | | | extrusion | | |
| Comparative | 49.3 | — | — | — | — | 139 | 0.78 | 24 | Kneading | 97.00 | None |
| Example 2 | | | | | | | | | extrusion | | |
| Comparative | 32.5 | — | — | — | 11.6 | 337 | 0.34 | 4 | Kneading | 96.30 | None |
| Example 3 | | | | | | | | | extrusion | | |
| Comparative | 42.0 | 5.0 | 9.0 | 0.1 | — | 112 | 0.63 | 22 | Supporting | 99.20 | Delaminated |
| Example 4 | | | | | | | | | | | |

TABLE 2

| | Chlorine decomposition rate |
|---|---|
| | of PFC mixed gas |
| | (%) |
| Example 9 | 99.52 |
| Example 10 | 99.59 |

### REFERENCE SIGNS LIST

1. Exhaust gas treatment apparatus
2. First removal device (scrubber)
3. Chlorine gas decomposition catalyst
4. Reactor
5. Heating device
6. Cooling device
7. Second removal device (scrubber)
8. Blower
9, 10, 11. Pipes
a. Exhaust gas
b. Water
b1. Scrubber water
b2. Cooling water
c. Abated exhaust gas
d. Abated exhaust liquid

1. A chlorine gas decomposition catalyst, comprising a composite oxide (X) of Al and at least one element M1 selected from the group consisting of Ce and Co.

2. The chlorine gas decomposition catalyst according to claim 1, wherein the composite oxide (X) has a Ce content of 5% by mass or more and a Co content of 5% by mass or more.

3. The chlorine gas decomposition catalyst according to claim 1, wherein the composite oxide (X) is a composite oxide of the element M1, Al and Cu.

4. The chlorine gas decomposition catalyst according to claim 3, wherein the composite oxide (X) has a Cu content of 0.1% by mass or more.

5. The chlorine gas decomposition catalyst according to claim 1, having a specific surface area of 50 m²/g or more, a total pore volume of 0.3 cm³/g or more and an average pore diameter of 5 nm or more.

6. The chlorine gas decomposition catalyst according to claim 1, wherein the composite oxide (X) is a porous substance.

7. The chlorine gas decomposition catalyst according to claim 1, for decomposing chlorine gas contained in exhaust gas.

8. The chlorine gas decomposition catalyst according to claim 7, wherein the exhaust gas contains a perfluoro compound.

9. An exhaust gas treatment apparatus comprising a reactor into which exhaust gas comprising chlorine gas is introduced, wherein the reactor is equipped with the chlorine gas decomposition catalyst according to claim 1.

10. The exhaust gas treatment apparatus according to claim 9, wherein the exhaust gas contains a perfluoro compound.

11. The exhaust gas treatment apparatus according to claim 10, further comprising a reactor filled with a perfluoro compound decomposition catalyst.

12. The exhaust gas treatment apparatus according to claim 9, comprising a supply device that supplies water to the exhaust gas.

13. The exhaust gas treatment apparatus according to claim 9, comprising a heating device that heats the exhaust gas.

14. The exhaust gas treatment apparatus according to claim 13, comprising a temperature detector that detects a temperature of the exhaust gas supplied to the reactor, and a control device that controls the heating device based on a temperature measured by the temperature detector.

15. The exhaust gas treatment apparatus according to claim 9, comprising a cooling device that cools gas discharged from the reactor.

16. The exhaust gas treatment apparatus according to claim 9, comprising a removal device that removes an acid gas from gas discharged from the reactor.

17. A method for decomposing chlorine gas, comprising bringing gas containing chlorine gas into contact with the chlorine gas decomposition catalyst according claim 1 in the presence of water.
